(19) United States
(12) Patent Application Publication
(10) Pub. No.: US 2021/0107138 A1
(43) Pub. Date: Apr. 15, 2021

(54) Air Gap Magnetic Mobile Robot with Adjustable Headpiece

(71) Applicant: DCP Waterjet Holdings, Inc., Park City, UT (US)

(72) Inventors: Stephen R. Johnson, Palm Beach Gardens, FL (US); John Odwazny, Palm City, FL (US)

(21) Appl. No.: 17/067,563

(22) Filed: Oct. 9, 2020

Related U.S. Application Data
(60) Provisional application No. 62/913,194, filed on Oct. 10, 2019.

(51) Int. Cl. B25J 9/12; B25J 5/00; B25J 15/06; B25J 15/00; B25J 13/00

(52) U.S. Cl. CPC B25J 9/126; B25J 5/007; B25J 13/006; B25J 15/0019; B25J 15/0608

(57) ABSTRACT

A mobile robot having a main chassis supporting a headpiece for cleaning, stripping, reconditioning or refurbishing a coating on a metal work piece. A remote controlled power module allows for locomotion of the chassis which is held to the work piece by magnets spaced apart from the work piece by a predetermined space. The chassis provides operational control of a headpiece capable of unique positioning that is possible in view of the separated chassis and headpiece combination.

### RELATED APPLICATIONS

This application claims the benefit of U.S. Provisional Patent Application No. 62/913,194, filed Oct. 10, 2019, the entire contents of which are incorporated herein by reference.

### FIELD OF THE INVENTION

The present invention pertains to a method for the removal of surface coatings from various surfaces and, in particular, to a magnetic mobile robot having a main chassis with an adjustable headpiece.

### BACKGROUND OF THE INVENTION

Mobile robots that have magnetic wheels in contact with the surface upon which they work are conventional. However, the movement of some of the robots across the metal surface may cause ancillary damage to the surface in the area of contact. Because of the rigidity of the magnetic wheels and the magnetic force between the wheels and the rigid work surface, the paint or protective coatings on the work piece are crushed.

The prior art robots were not capable of treating the entire surface of the structures upon which they were attached because the working head or heads are located inboard of the wheels.

This invention is directed toward elimination of these characteristics of the prior art devices. Specifically, the magnets of this invention are not in contact with the work piece. Also, the working heads are located to allow the heads to extend to or beyond the margins of the work piece.

It is known that pressurized water can be used in the removal of coatings. The application of coatings in the marine environment is an excellent example of how coatings are used in demanding circumstances. On a ship, coatings are applied to all exposed metal surfaces including those that are submerged for long periods of time, namely the ship's hull. The corrosive properties of salt water together with abrasive wear due to the movement of a ship through the water requires that even the most durable coating be replaced periodically.

When a coating is applied to the ship's hull, the degree of surface roughness of submerged portions of a ship has a great effect on both ship fuel efficiency and the speed which can be achieved at a given propeller revolution rate. Roughness can be caused by degradation of the coating which can also lead to marine growth further adding to the roughness or “fouling” of the bottom.

Fouling of ship bottoms not only reduces fuel efficiency, thus increasing operating costs, but also attacks the integrity of the coating which leads to corrosion and metal fatigue. Corrosion damage to hulls can lead to costly repairs, loss of operating time, and if unchecked, to the premature scrapping of the vessel. Environmental laws regulate fouling prevention by limiting the types of paint which may be used, especially those containing organotin/tributylin and cuprous oxides which are most effective in controlling calcerous fouling. Thus, because the most effective preventive measures against fouling are unavailable, it has become necessary to replace coatings more frequently. The coatings which can be applied under current laws need a superior surface finish in order to extend the life of the coating on the surface. Such a surface can only be attained if the metal is properly cleaned before coating.

### SUMMARY OF THE INVENTION

Disclosed is a magnetic mobile robot for traversing the surface of a work piece without damaging the protective coatings on the surface of the work piece as a result of contact between the robot and the surface. The mobile robot has a main chassis and a gimbal mounted working headpiece. The main chassis contains four wheels driven by one or more electrical motors. The wheels provide skid steering and include a coating, or are made of, that will not damage the surface of a work piece. The chassis is attached to a ferro metal work piece using permanent magnets that are spaced apart from the work piece by an air gap. The headpiece is attached to the chassis by an attachment arm along a midpoint of the chassis. The headpiece is adjustable allowing the headpiece to be offset from the chassis for trimming of a work piece project. The headpiece employs a shroud containing a high pressure nozzle capable for directing ultra high pressure water against the work piece.

The device can be used to refurbish any stationary or movable structures made of a metal having magnetic properties, such as buildings and vehicles. These structures include but are not limited to any iron or steel clad buildings, bridges, tunnels, pipe lines, ships, trains, cars, trucks, and military vehicles of all types.

A potential benefit of certain embodiments is to provide a chassis with a headpiece wherein the headpiece permits surface conditioning at a position offset from the chassis.

Another potential benefit of certain embodiments is to provide a chassis with a headpiece that allows surface conditioning close to obstructions from two directions.

Still another potential benefit of certain embodiments is to provide a headpiece that can be separated from a work piece by wheels or suspended from the surface where the headpiece can float over the work piece.

Another potential benefit of certain embodiments is to provide a headpiece that can rotate to a position in front of the chassis to a position above the chassis to allow nozzle servicing.

Yet another potential benefit of certain embodiments is to provide a headpiece that is attached to a chassis by use of a gimbal, wherein the gimbal allows the headpiece to conform to uneven surfaces.

Yet still another potential benefit of certain embodiments is to provide a headpiece that is adjustably attached to a chassis to allow for lateral movement to allow a wider forward path.

Still another potential benefit of certain embodiments is to provide a chassis that has a single attachment point to allow multiple tools to be attached such a camera, a thickness gauge, or alternative cutting heads.

It is a further potential benefit of certain embodiments to provide a magnetically supported mobile robot with working heads which clean, strip, recondition and/or refurbish the surface of a work piece.

It is yet another potential benefit of certain embodiments to provide an environmentally safe protective structure about the working heads that prevents escape of debris from the robot. The protective structure additionally guides the waste products into return lines for further processing.

Still further, it is a potential benefit of certain embodiments to teach an environmentally safe process of stripping accretions, deposits, plant and animal forms, and protective coatings from magnetically active metal surfaces and disposing of the waste products.

Other benefits and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE FIGURES

FIG. 1 is a perspective view of the ultra high pressure surface coating removal device of the instant invention;

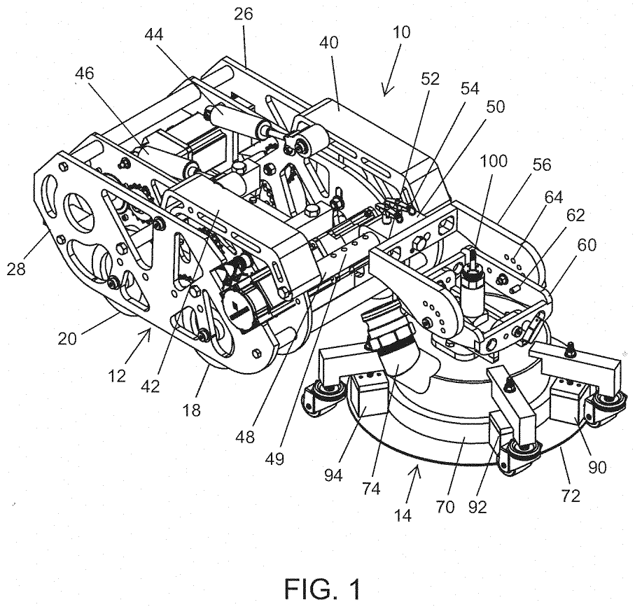

FIG. 2 is a top view thereof;

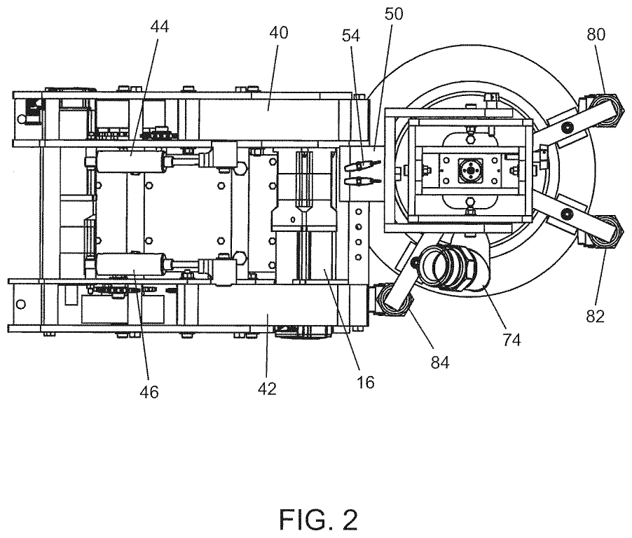

FIG. 3 is a right side view thereof;

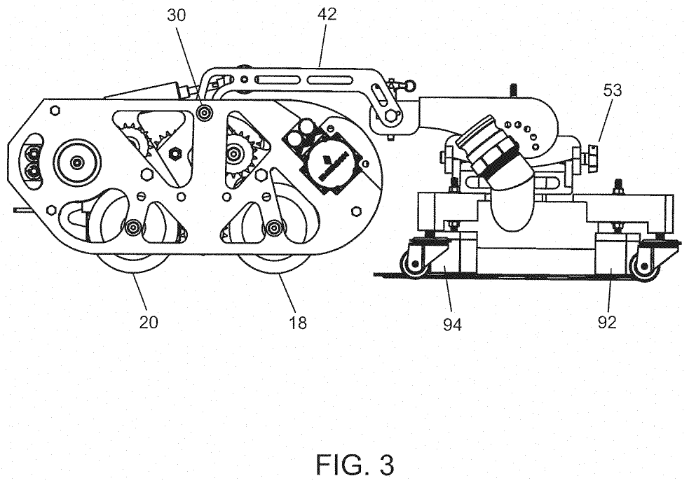

FIG. 4 is a left side view thereof;

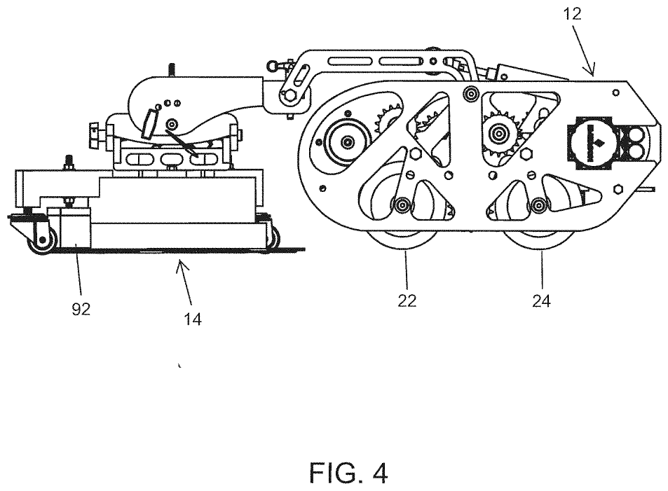

FIG. 5 is a front view thereof;

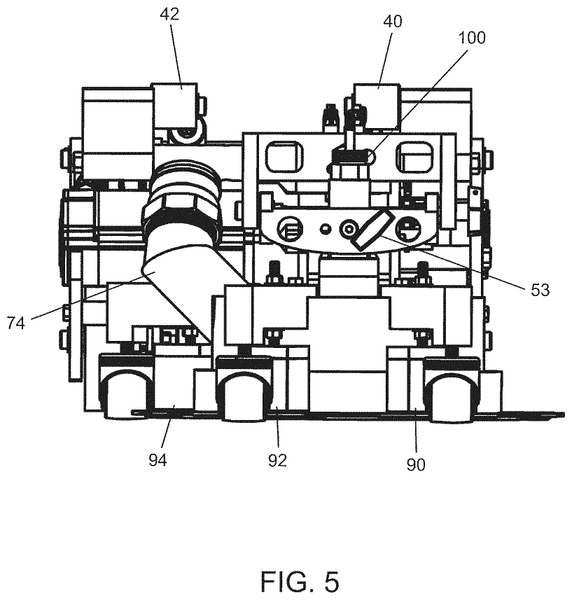

FIG. 6 is a rear view thereof;

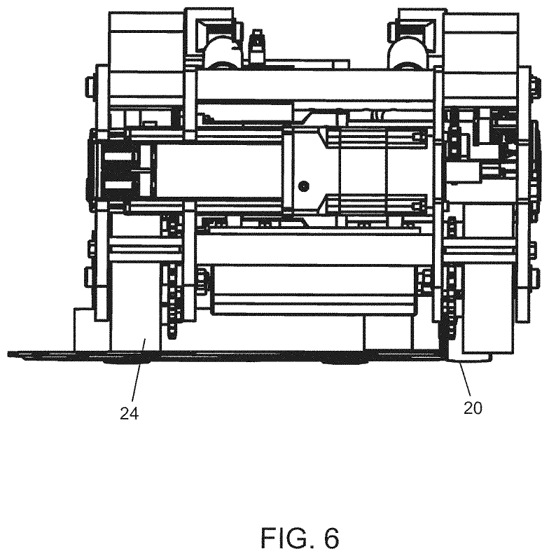

FIG. 7 is a bottom view thereof;

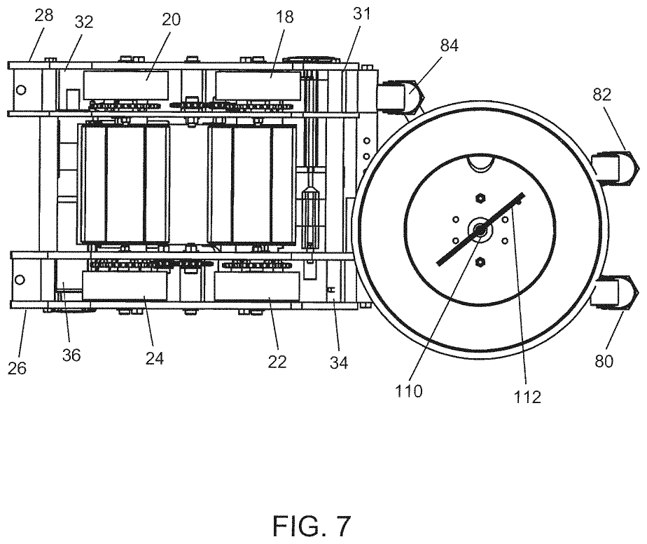

FIG. 8 is a perspective view with the head piece of the device in a raised position; and

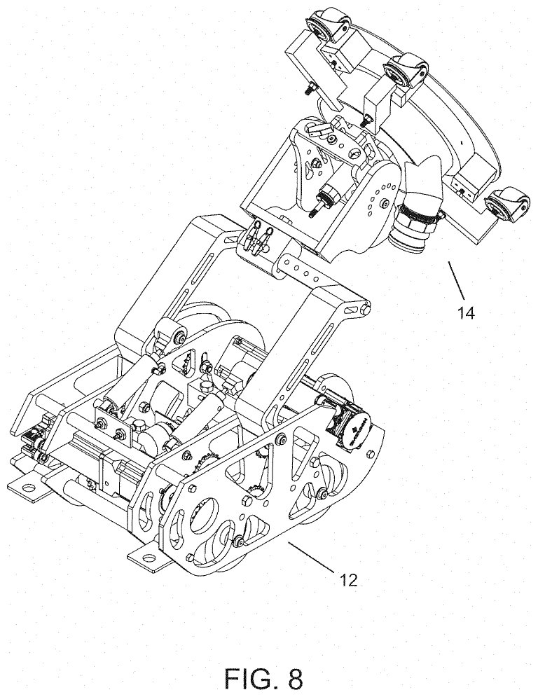

FIG. 9 is a pictorial view of the device on a curved work piece.

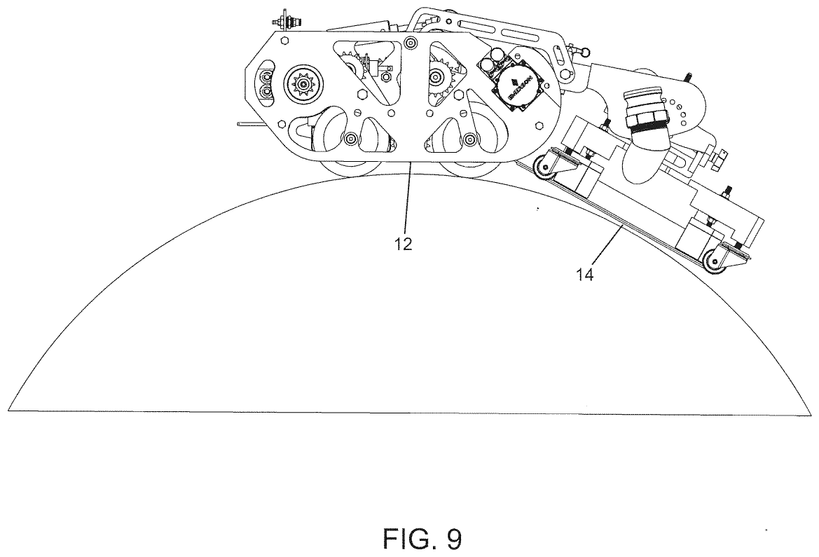

### DETAILED DESCRIPTION OF THE INVENTION

Referring now to the Figures, disclosed is the ultra high pressure surface coating removal device 10 having a main chassis 12 coupled to a headpiece 14. The chassis 10 has a power module made up of an electric motor 16 driving at least one wheel 18. The chassis 12 having frontal wheels 18 and 22, and trailing wheels 20 and 24. Each wheel is preferably driven independently by its own motor which allows ease of maneuvering by skid steering or by use of a transaxle. The transaxle has the ability to turn one wheel in one direction and the other wheel in the opposite direction, simultaneously, to spin the robot in its own length. The transaxle can also stop one wheel while the other is turning to change direction of the path of the robot. The power module may be controlled remotely by wire or wireless signaling from a computer or manual controller to maneuver the robot to traverse the entire surface of the work piece. Alternatively or additionally, the power module may have an on-board computer to operate the power and working head components in response to commands received by wire or wireless.

A remote controller, either attached by RF or a power cord, allows an operator to control the direction and transfer speed of the chassis. The chassis 12 is defined by a left frame member 26 and a right frame member 28 that are coupled together and includes a centrally disposed pivot point 30 located along the upper portion of the frame members. Frame member 28 supports a left frontal area magnet 31 and left rear area magnet 32. Frame member 26 support right frontal area magnet 34 and rear area magnet 36.

The magnets are preferably Halbach array and spaced to prevent contact with the work piece. The spacing need only be a slight air gap to allow maximum magnetic attraction between the magnets and the work piece, without actually touching the work piece. In this arrangement the magnets are constructed and arranged to hold the chassis against the work piece. The magnets are shaped and disposed to gain the strongest magnetic attraction between the chassis and the work piece. The magnets may be oriented in a manner to provide the greatest amount of magnetic force. The magnets may be incorporated into the robot in another alternative construction, such as positioning the magnets to the bottom circumference of the shrouds. The flexible skirts of the shroud may extend below the magnets and form the seal between the headpiece and the work piece.

The wheels providing the only contact with the work piece, preferably the wheels constructed of a non-marring material. Each wheel has a tire made of rubber of other polymer, such as polyurethane, polystyrene and nylon that will withstand the compression forces of the magnets. The tire material may be continuous or cellular. The tire may be molded on the magnetic wheel or held in place by friction or adhesives. Also, the wheels may have structure, such as a groove, to retain the tires in a specific relationship to the wheels.

The tire is capable of withstanding the magnetic force exerted between the wheels and the work piece while maintaining a constant space between the wheels and the work piece. Any deformation of the tire results in a larger foot print in contact with the work piece. However, the thickness of the tire and the resultant space between the wheel and the work piece is optimized to correspond to the distance within which the greatest magnetic attraction is present. For example, a tire thickness of at least 1/32 inch results in satisfactory magnetic attraction. The tires may have larger thicknesses up to the point that magnetic attraction between the wheels and the work piece is lost. The specific tire thickness will vary with the strength of the magnetic force generated by the magnets. The tires may be solid or pneumatic or filled with other fluids. The tires also cushion the contact between the magnetic wheels and the work surface. Any deformation of the tire increases the area in contact with the work piece and decreases the pounds per square inch of pressure exerted on the work surface. When the robot traverses the work surface, the tires do not damage any protective coating or paint. This becomes more important when the surface coating of the work piece is not completely removed but merely refurbished. If the surface coating is crushed by the wheels, the refurbished coating will have underlying areas of permanent damage which reduce the life expectancy of the coating.

The headpiece 14 is pivotally attached to the chassis 12 using a left arm member 40 and right arm member 42 rotatably attached to the pivot point 30. The arm members 40 and 42 are rotated by electric piston actuators 44 and 46 allowing adjustment of the headpiece angle of operation to accommodate various work piece curvatures. Retraction of the piston actuators can be used to position the headpiece 14 over the chassis allowing for ease of servicing. A positioning bar 48 is located along the distal end of each arm member 40, 42. The positioning bar 48 having a series of apertures 49 constructed and arranged to operate with a positioning block 52 having at least one spring loaded retractable pinion 54. The positioning block 52 support a U-shaped saddle 56 coupled to a gimbal 60 that allows the work piece 14 to adjust to any surface curvature variation. A limiter is provided by use of a pinion 62 that can be placed into an adjoining aperture 64. The headpiece 14 can be offset from the chassis by movement of the positioning block 52. The gimbal 60 can be limited in rotation by an adjuster limiter 53 adjustment.

The headpiece 14 is defined by a frame 70 having a shroud 72 designed to inhibit debris from escaping the frame. An exhaust guide 74 is coupled to a vacuum hose, not shown, for removal of debris removed from the work piece. The exhaust guide 74 removes the debris by a centrifuge action which directs the momentum of the cleaning fluid out of the shroud.

In a preferred embodiment, the headpiece employs two leading wheels 80 and 82 and a trailing wheel 84 which are mounted on casters to allow ease of movement. Magnets 90 and 92 are positioned alongside the leading wheels and magnet 94 is positioned next to the trailing wheel. As with the previous magnets used on the chassis, the headpiece magnets are constructed and arranged to position the headpiece against the work piece at all times. The headpiece may receive water pressure as high as 60,000 psi delivered through the water jet inlet 100. It should be noted that the left side of the headpiece is free of interference with the chassis, wherein the frame can abut an edge of a work piece, or pass over surface mounted items that would otherwise not be possible if a support wheel was mounted to the frame at this location. The shroud 72 allows the water jets to be laterally displaced from each other to cover a larger area of the work piece. Depending on the direction of movement of the robot, the headpiece allows surface conditioning close to obstructions from two directions.

A working head 110 rotates inside the frame 70 in response to high pressure fluid from supply line traversing obliquely angled bores 112. The high pressure fluid flows through the bores 112 and impinges upon the work surface. The rotary momentum of the fluid continues about the head confined by the shroud and skirt stripping the coating from the work surface. The fluid carries the debris from the surface into the exhaust guide 74. A vacuum line, not shown, is connected to the exhaust guide 74 to remove any residual fluid and debris. The entire stripping process is accomplished without releasing any debris into the atmosphere.

The pressure and rotary motion of the high pressure fluid impinging on the work surface act to strip the surface away from the underlying structure leaving a bare metal surface, if desired. In some instances, it may not be desirable to completely remove the protective coating on the structure. By adjusting the pressure of the fluid, or the speed of movement of the robot, or the distance of the orifices from the work surface, or a combination of these variables, the coating may be removed to the bare metal or the depth can be controlled.

The high pressure fluid used in the process may be water or other suitable fluid. The water jet ultra high pressure at the orifices is in the range of 35,000 pounds per square inch (psi) to 60,000 psi produced by a positive displacement pump. The orifice size is sufficient to permit a fluid flow in the range of 1,500 feet per second (ft/sec) to 3,000 ft/sec.

The chassis may also be equipped with attachments (not shown) such a camera, a thickness gauge, or alternative cutting heads.

It is to be understood that while a certain form of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

What is claimed is:

1. A robot comprising:
a chassis having a plurality of wheels attached thereto;
a power module comprising an electric motor driving at least one wheel of the plurality of wheels;
a headpiece adjustably attached to the chassis; and
a plurality of permanent magnets attached to the chassis,
wherein the robot is configured to traverse a surface of a work piece having a protective coating provided thereon, and
wherein the permanent magnets are configured to magnetically couple the chassis to the work piece, wherein the permanent magnets are configured to be spaced apart from the surface of the work piece by an air gap when the wheels of the chassis are in contact with the surface of the work piece.

2. The robot of claim 1, wherein the headpiece is attached to the chassis by a gimbal.

3. The robot of claim 1, further comprising a remote controller operably coupled to the chassis and configured to allow an operator to control a direction and transfer speed of the chassis.

4. The robot of claim 1, wherein the headpiece comprises a shroud.

5. The robot of claim 1, wherein the wheels comprise a non-marring material.

6. The robot of claim 1, further comprising at least one wheel coupled to the headpiece.

7. The robot of claim 1, further comprising an attachment point on the chassis configured to allow a tool to be attached to the chassis.
